(19) United States
(12) Patent Application Publication
(10) Pub. No.: US 2026/0008434 A1
(43) Pub. Date: Jan. 8, 2026

(54) INTELLIGENT DRIVER ASSISTANCE SYSTEMS AND METHODS FOR USE IN CONNECTED VEHICLES

(71) Applicant: AT&T Intellectual Property I, L.P., Atlanta, GA (US)

(72) Inventor: Wei Wang, Montclair, NJ (US)

(73) Assignee: AT&T Intellectual Property I, L.P., Atlanta, GA (US)

(21) Appl. No.: 18/764,724

(22) Filed: Jul. 5, 2024

(51) Int. Cl. B60R 25/25; B60R 25/30

(52) U.S. Cl. CPC B60R 25/25; B60R 25/30

(57) ABSTRACT

Aspects of the subject disclosure may include, for example scanning, by a processing system including a processor arranged in a steering wheel, identification information of a user and information of a vehicle associated with the user using a first group of sensors integrated with or arranged proximate to the steering wheel, verifying, by the processing system, the identification information of the user and the vehicle associated with the user, upon the verification, registering and storing, by the processing system, the verified identification information in a data storage of the steering wheel, and outputting, by the processing system, the verified identification information on a user interface arranged in connection with the steering wheel of the vehicle. Other embodiments are disclosed.

### FIELD OF THE DISCLOSURE

The subject disclosure relates to intelligent driver assistance systems and methods for use in connected cars.

### BACKGROUND

Connected cars include vehicles that can communicate with other systems outside of vehicles using internet access and sensors. The connectivity enables drivers and passengers to engage in various services, such as navigation, safety related services, autonomous driving, etc. It is convenient and effective to use structures, elements, devices, etc. which are present in connected vehicles to accommodate various services.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of an intelligent driver assistance system implemented in a steering wheel in accordance with various aspects described herein.

FIG. 2C depicts an illustrative embodiment of a driver identification phase of an intelligent driver assistant system in accordance with various aspects described herein.

FIG. 2D depicts an illustrative embodiment of a motion phase of an intelligent driver assistant system in accordance with various aspects described herein.

FIG. 2E depicts an illustrative embodiment of a new driver identification phase of an intelligent driver assistant system in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for intelligent driver assistance systems and methods for use in connected cars. By way of example, a steering wheel of a connected vehicle can be utilized to scan, store and retrieve driver identification information to assist drivers. After verifying the driver identification information, the steering wheel utilizes the verified identification information to authenticate drivers, control vehicle access, prevent vehicle theft, etc. Other embodiments are described in the subject disclosure.

One or more aspects of the subject disclosure are directed to a device, including a processing system including a processor and a memory that stores executable instructions that, when executed by the processing system, facilitate performance of operations. The operations include obtaining identification information of a driver and information of a connected car associated with the driver using a first group of sensors integrated with the device or arranged in an interior structure of the connected car; transmitting the identification information to a relevant authority system via a communication interface of the connected car; receiving verification of the identification information of the driver and the connected car associated with the driver; upon the receiving the verification, registering and storing the verified identification information; and outputting the verified identification information on a user interface arranged in connection with the interior structure of the connected car.

One or more aspects of the subject disclosure is directed to a machine-readable medium, comprising executable instructions that, when executed by a processing system including a processor, facilitate performance of operations. The operations include scanning identification information of a user and information of a connected car associated with the user using a first group of sensors integrated with or arranged in a steering wheel of the connected car; transmitting the identification information to a relevant authority system via a communication interface of the connected car; receiving verification of the identification information of the user and the connected car associated with the user; upon the verification, registering and storing the verified identification information; and outputting the verified identification information on a user interface arranged in connection with the steering wheel of the connected car.

One or more aspects of the subject disclosure is directed to a method including scanning, by a processing system including a processor arranged in a steering wheel, identification information of a user and information of a vehicle associated with the user using a first group of sensors integrated with or arranged proximate to the steering wheel; verifying, by the processing system, the identification information of the user and the vehicle associated with the user; upon the verification, registering and storing, by the processing system, the verified identification information; and outputting, by the processing system, the verified identification information on a user interface arranged in connection with the steering wheel of the vehicle.

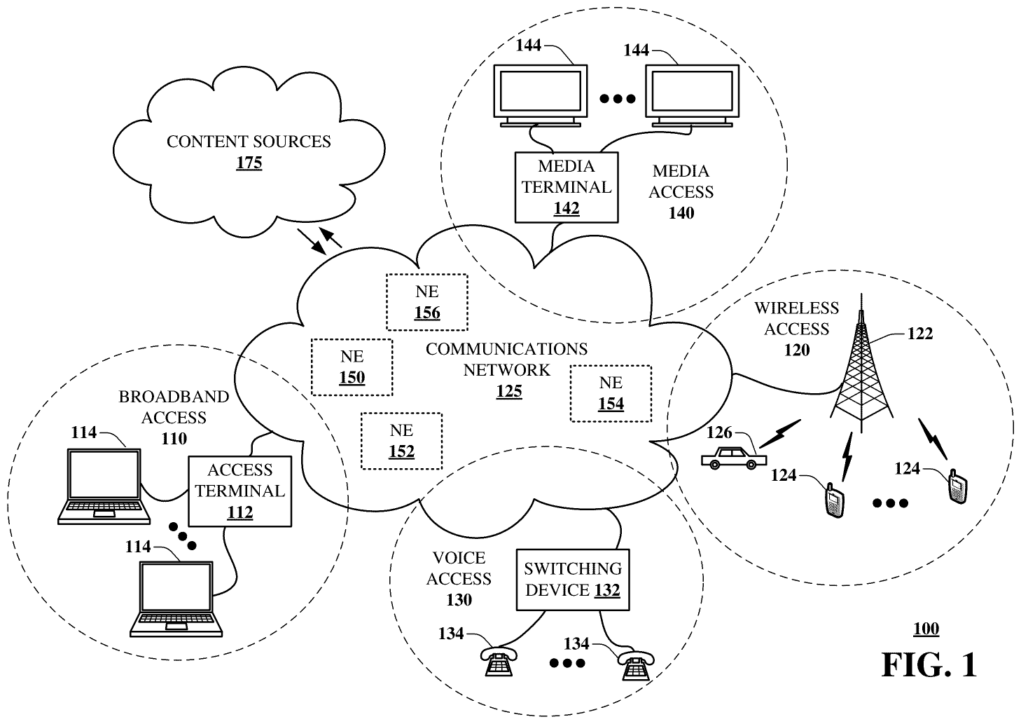

Referring now to FIG. 1, a block diagram is shown illustrating an example, non-limiting embodiment of a system 100 in accordance with various aspects described herein. For example, system 100 can facilitate in whole or in part intelligent driver assistance systems and methods for use in connected cars. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

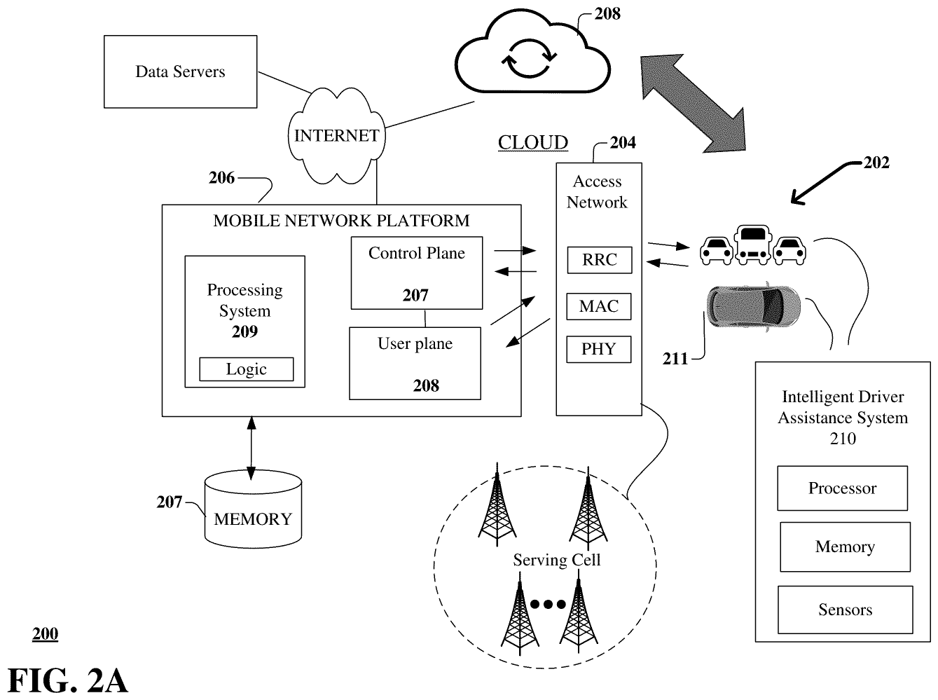

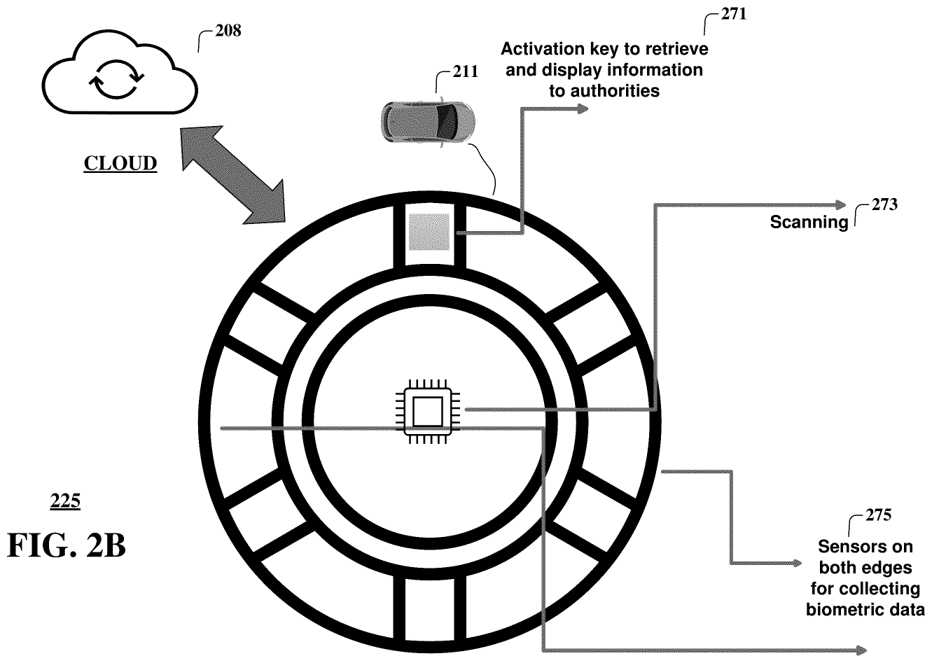

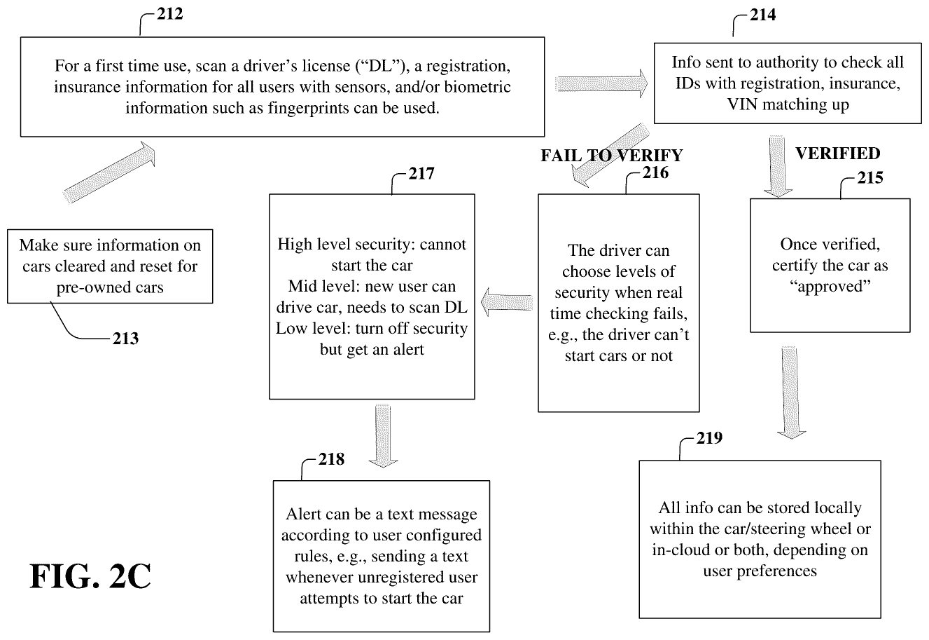

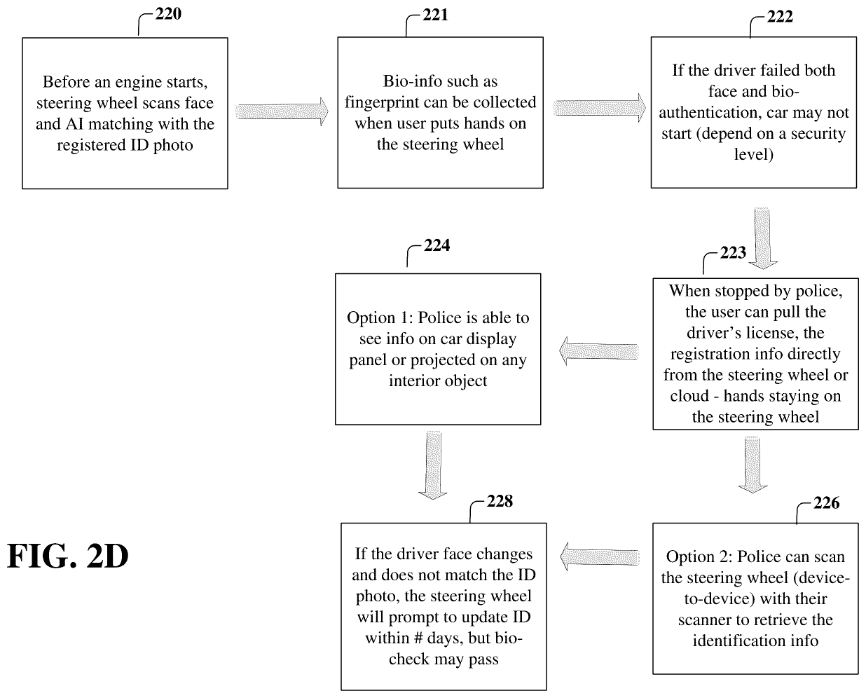

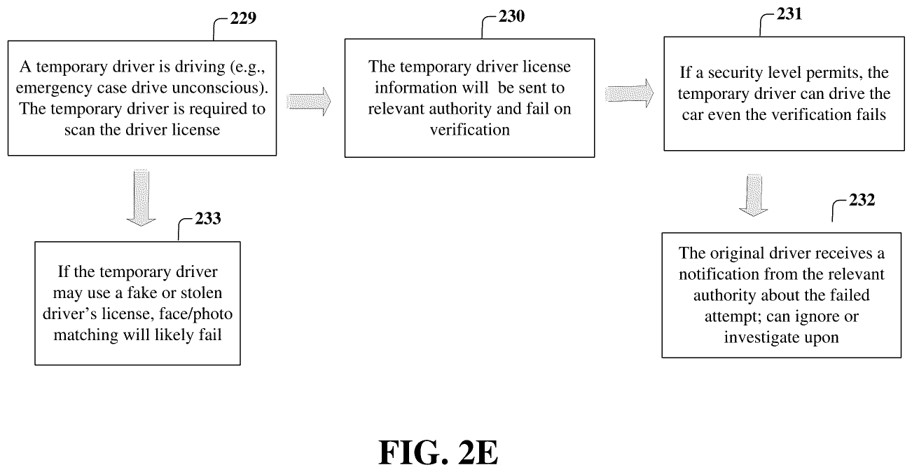

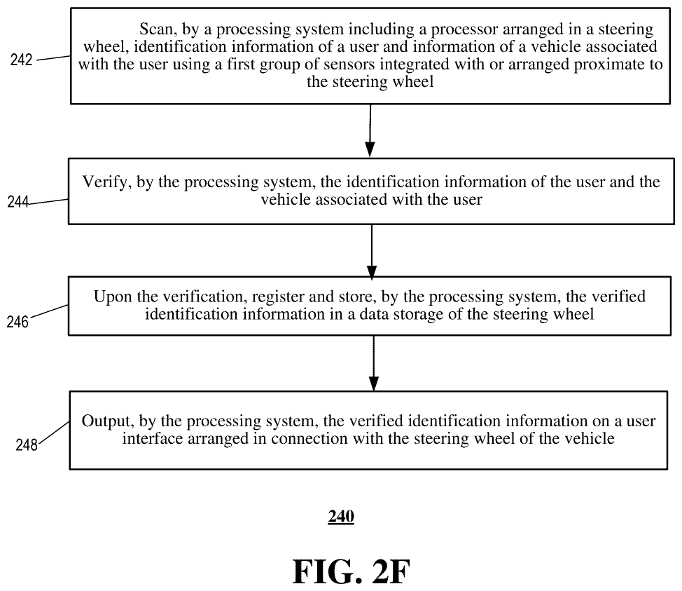

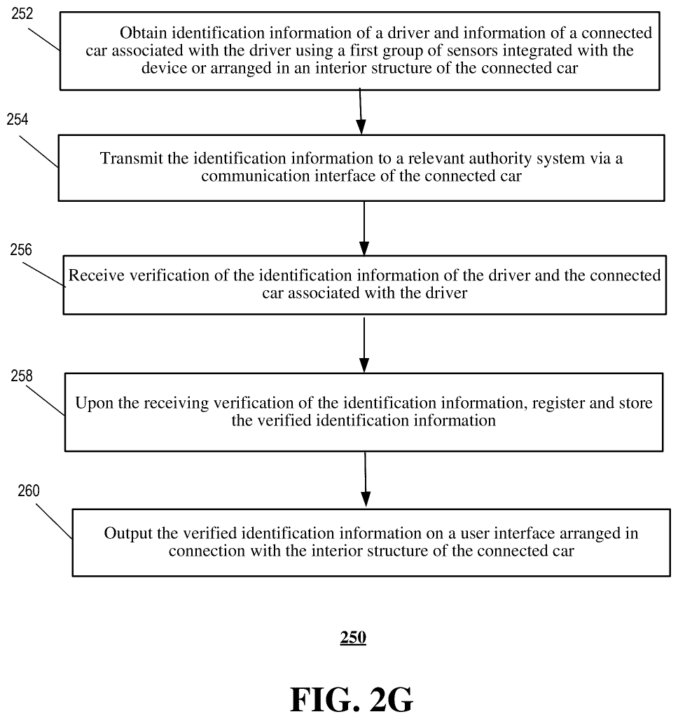

FIG. 2A is a block diagram illustrating an example, non-limiting embodiment of a system 200 functioning within the communication network of FIG. 1 in accordance with various aspects described herein. The system 200 includes connected cars 202 having the connectivity and facilitating various functions, services, etc. Connected cars include vehicles that can communicate with other systems outside of vehicles using internet access and sensors. The connectivity enables drivers and passengers to engage in various services, such as navigation, safety related services, autonomous driving, etc. As depicted in FIG. 2A, the connected cars 202 are communicatively coupled to a cloud 208 via an access network 204 and a mobile network platform 206. The connected cars 202 are coupled to data servers via the internet and download or receive data from the data servers. The connected cars 202 may be equipped with one or more transmitter (Tx) devices and/or one or more receiver (Rx) devices configured to communicate with, and utilize network resources of, the system 200.

In various embodiments, the connected cars 202 may include any (e.g., manually controllable or autonomous) personal or commercial vehicle or device that is equipped with one or more types of devices or components for performing various actions. In certain embodiments, the connected cars 202 may include one or more radio equipment configured to function as a cellular relay (e.g., low-powered cellular radio access (or small cell) node(s)), one or more sensors (e.g., image sensor(s), infrared sensor(s), near infrared camera(s), radar system(s), light detection and ranging (LIDAR) system(s), biological sensor(s), temperature sensor(s), chemical sensor(s), humidity sensor(s), and/or the like) for capturing information/data in an environment of the connected cars 202, one or more mechanical limbs for physically manipulating external objects, and/or the like. In some embodiments, one or more connected cars 202 may be deployed to provide network connectivity for other UE(s). In certain embodiments, the connected cars 202 may provide network connectivity by way of wireless “tethering” to (e.g., a base station or the like of) an access network like the access network 204 or a different access network (i.e., one that is not experiencing a traffic surge condition) and/or via a wired link (e.g., over a fiber connection) to a network device (e.g., edge computing device or the like) that has a backhaul connection to the mobile network platform. The connected cars 202 may, additionally, or alternatively, communicate data (e.g., control data, user data, etc.) via the wireless tethering or wired link.

In various embodiments, the mobile network platform 206 may include network devices and/or systems that provide a variety of functions. In certain embodiments, the mobile network platform 206 may be implemented in a cloud architecture. In some embodiments, the mobile network platform 206 implements LTE networks. In the LTE networks, examples of network functions provided by, or included, in the mobile network platform 206, include a Mobility Management Entity (MME) function, a Serving Gateway (SGW) and other network functions such as a Packet Data Network Gateway (PGW), Home Subscriber Server (HSS), etc. The MME is responsible for an idle mode of user equipment (UE) by handling paging and tagging procedures. The MME further handles selecting a serving gateway for a UE at an initial attachment and at the time of intra-LTE handover. The MME is also involved with authentication of a user by interacting with the HSS.

The present disclosure is not limited to the LTE networks. The mobile network platform 206 facilitates and support 5G, 6G, or any higher generation of cellular networks. The 5G networks include a control plane 207 and a user plane 208. Examples of functions provided by, or included, in the control plane 207 of the mobile network platform 206 include an access mobility function (AMF) configured to facilitate mobility management in a control plane of the network system (including, for instance, providing UE mobility information associated with the access network(s) 204 and/or the connected cars 202 to the mobile network platform 206), a user plane function (UPF) configured to provide access to a data network, such as a packet data network (PDN), in a user (or data) plane of the system 200, a Unified Data Management (UDM) function, a Session Management Function (SMF), a policy control function (PCF), and/or the like. The mobile network platform 206 may be in communication with one or more other networks (e.g., one or more content delivery networks (CDNs)), one or more services, and/or one or more devices. In one or more embodiments, the mobile network platform 206 may include one or more devices implementing other functions, such as a master user database server device for network access management, a PDN gateway server device for facilitating access to a PDN, and/or the like. The mobile network platform 206 may include various physical/virtual resources, including server devices, virtual environments, databases, and so on.

In various embodiments, the access network 204 may include a wireless radio access network (RAN), a Wi-Fi network, and/or a wireline network. In exemplary embodiments, the access network 204 may be implemented in open source software (e.g., in an OpenAirInterface (OAI) wireless technology platform). The access network 204 may include network resources, such as one or more physical access resources and/or one or more virtual access resources. Physical access resources can include base station(s) (e.g., one or more eNodeBs, one or more gNodeBs, or the like, such as base stations), one or more satellites, one or more Gigabyte Passive Optical Networks (GPONs) or related components (e.g., Optical Line Terminal(s) (OLT), Optical Network Unit(s) (ONU), etc.), and/or the like. A base station may employ any suitable radio access technology (RAT), such as 4G/LTE, 5G, 6G, or any higher generation RAT.

One or more edge computing devices (e.g., multi-access edge computing (MEC) devices or the like) may also be included in or associated with the access network 204. Virtual access resources can include a voice service system (e.g., a hardware and/or software implementation of voice-related functions), a video service system (e.g., a hardware and/or software implementation of video-related functions, such as coder-decoder or compression-decompression (CODEC) components or the like), a security service system (e.g., a hardware and/or software implementation of security-related functions), and/or the like. In one or more embodiments, the access network 204 may include any number/types of physical/virtual access resources and various types of heterogeneous cell configurations with various quantities of cells and/or types of cells.

In certain embodiments, the access network 204 may be implemented as a virtual RAN, where radio/wireline functions are implemented as general-purpose applications/apps that operate in virtualized environments and interact with physical resources either directly or via full/partial hardware emulation. Virtualized software radio applications can be delivered as a service and managed through a cloud controller. Here, base stations may be implemented as (e.g., passive) distributed radio elements connected to a centralized baseband processing pool. In some embodiments, the access network 204 may include, or communicate with, a RAN intelligent controller (RIC).

In various embodiments, the system 200 includes an intelligent driver assistance system 210 for use in the connected cars 202. The intelligent driver assistance system 210 have various use cases. For instance, when a car is pulled over by a police officer and a driver is asked to present a driver's license and a vehicle registration, a driver may need to reach out or retrieve these documents from a hidden place such as a glove compartment of a vehicle. Such driver's action may cause unnecessary confusion and tension to both a driver and a police officer. If a driver is involved in a car accident, first responders need to know health insurance information and preconditions of drivers and a driver may be unable to produce such documentation due to injuries or being unconscious. Furthermore, car accidents are likely to happen when a driver is distracted or dozing. A sensor that can easily detect such behavior or condition of a driver will likely help to avoid or mitigate the risk of car accidents.

In various embodiments, the intelligent driver assistance system 210 can be implemented, arranged or placed in the connected cars 202. By way of example only, the intelligent driver assistant system 210 can be implemented by utilizing structures, devices, elements, systems, etc. present in the connected cars 202. For instance, the intelligent driver assistance systems and methods can be arranged and configured in a steering wheel of the connected cars 202, as depicted in FIG. 2B below. Additionally, or alternatively, the intelligent driver assistance systems and methods can be arranged and configured in a cover for the steering wheel of the connected cars 202. The intelligent driver assistance system 210 includes a processing system including a processor and a memory storing relevant instructions for assisting a driver. Additionally, or alternatively, the intelligent driver assistance system 210 can use processing systems of the connected cars and the connectivity path of the connected cars 202 via the access network 204 and the mobile network platform 206. The intelligent driver assistance systems and methods can be connected to the cloud 208 via the internet through the access network 204 and the mobile network platform 206.

In various embodiments, the intelligent driver assistance system 210 can be arranged in the access network 204, the mobile network platform 206, or the cloud 208 such that the connected cars 202 can download applications and execute the applications.

In various embodiments, the intelligent driver assistance system 210 includes a processor, a memory storing instructions which are executable by the processor, and various sensors as needed. In some embodiments, sensors used with the intelligent driver assistance system 210 may be sensors included in the connected car 211. The intelligent driver assistance system 210 may download intelligent driver assistance applications to run therein, or be remotely and externally controlled by systems and methods external to the connected vehicle 211. It is desirable to use structures, elements, devices, etc. present in a vehicle, the foregoing use cases can be accommodated. As one example, in a driver's seat, a driver's hands generally stay on a car's steering wheel. The steering wheel or a cover therefor may be a perfect spot or location to facilitate a driver identification, a vehicle identification, safety related measures, etc., as depicted in FIG. 2B.

FIG. 2B depicts an illustrative embodiment of an intelligent driver assistance system implemented in a steering wheel 225 in accordance with various aspects described herein. In various embodiments, when a driver is in a vehicle, hands of the driver typically stay on a steering wheel. The steering wheel is the most easily accessible and an operational part of a car for the driver while the car is in motion or parked. When stopped by police officers, it is required that hands be needed to be seen and likely be on the steering wheel in most cases and the steering wheel may be the best place to do any operation. The steering wheel is directly placed before a driver, thus has a perfect view of driver's face, postures, etc. In addition, the driver is sitting facing the steering wheel and the steering wheel is within a convenient reach of the driver. Thus, the steering wheel can be configured as a structure that scan driver's information, including driver's license, registration, or even health/car insurance or preconditions, as well as real-time facial expression or conditions, heartbeats, postures (e.g., distracted or dozing off, etc.), by way of example. The intelligent driver assistant system implemented in the steering wheel 225 (“the steering wheel system 225”) can load other information or other data to accommodate various use cases. The steering wheel system 225 can be used to assist law enforcement in anti-car theft cases, driver's health emergencies, car accidents, improved safety measures, or any other situations requiring instant access to the driver information. The driver can also use or rely on the steering wheel system 225 to store and retrieve information needed in various use cases.

In various embodiments, the steering wheel system 225 implemented in the steering wheel includes a group of sensors configured to scan documents such as a driver's license, vehicle registrations, insurance cards, etc. (as depicted in 273 in FIG. 2B). The group of sensors may be integrated with the steering wheel or arranged in the steering wheel or its cover. For instance, the driver places the driver's license at the center of the steering wheel and scans the license. A vehicle logo and any part of a steering wheel can be utilized to scan information, such as all driver's license, car registration, driver's health insurance etc. Alternatively, information or data scanned from a driver's license, vehicle registrations, insurance cards, etc. can be downloaded by using a smartphone or from the cloud 208. The scanned information can be stored in a memory arranged in the steering wheel and/or the cloud 208. By way of example, the group of sensors includes a scanner which serves as a tag, similar to radio frequency identification (RFID) devices, such that a reader can read information if scanned.

In various embodiments, the steering wheel system 225 further includes a second group of sensors 275 placed on both edges to collect biometric information. The system 225 further includes an activation key 271 to retrieve and display information to authorities. The system 225 is in communication with the cloud 208 where the information or data from the system 225 can be stored and retrieved as needed.

In various embodiments, the steering wheel system 225 can be arranged or implemented in a cover for the steering wheel of the connected car 211.

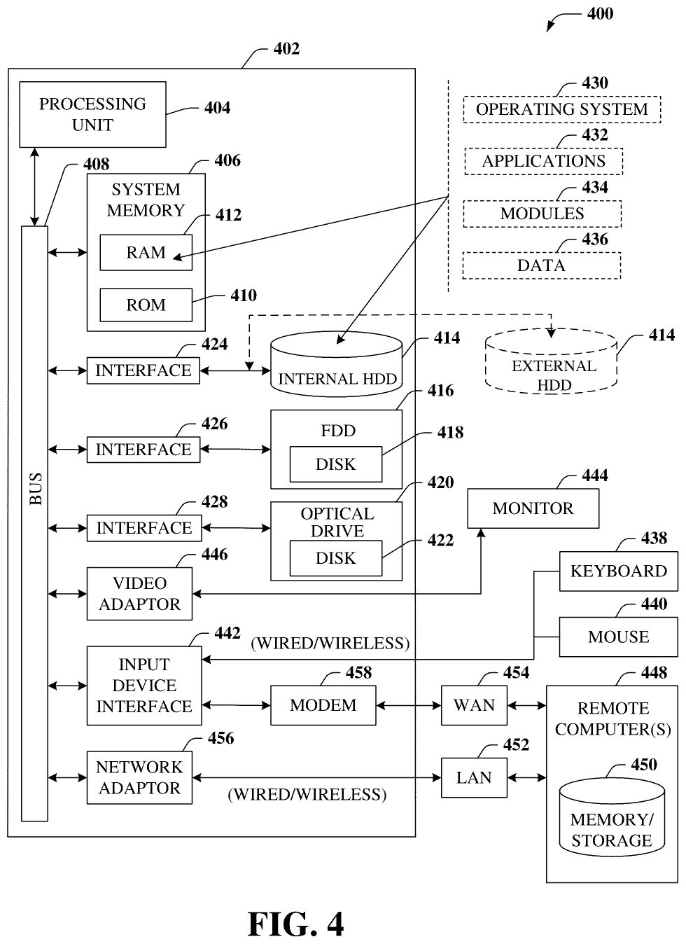

FIG. 2C depicts a non-limiting embodiment of a driver identification phase implemented in an intelligent driver assistant system in accordance with various aspects therein. The identification phase of the intelligent driver assistant system such as the steering wheel system 225 as depicted in FIG. 2B is described. The steering wheel system 225 includes a steering wheel where driver identification information and data are stored. In some embodiments, the steering wheel system 225 can be implemented or arranged in a cover for the steering wheel that may be detachable from or wearable on the steering wheel. The steering wheel system 225 includes a processing system having a processor, a memory, communication modules, etc. FIG. 4 illustrates a non-limiting embodiment of the processing system that can be used in the processing system of the system 225, as will be described in detail below.

As depicted in FIG. 2C, by way of example, for a first time use, a driver's license can be scanned and stored in the processing system having the memory which is arranged in the steering wheel system 225 (Block 212). The driver's license can be scanned using a sensor integrally arranged in the steering wheel, or sensor(s) located within an interior structure of the connected car 211, as shown in FIG. 2B. Additionally, or alternatively, the driver's license scanned externally, such as using a smartphone of the driver, can be downloaded using the communication module included in the processing system, etc.

In various embodiments, in addition to the driver's license, other types of data or information related to the identification of the driver can be loaded into the processing system of the steering wheel system 225 (Block 212). For instance, insurance information, a vehicle registration, etc. can be added to the processing system of the steering wheel. Additionally, or alternatively, biometric information such as the driver's fingerprint(s), the driver health information (a heartbeat rate, a medical history, primary care doctor information, etc.) can be added to the processing system of the steering wheel system 225 (Block 212). The driver's biometric information can be loaded, which includes the driver's fingerprints, the driver's eyes (e.g., iris), the driver's voice, the driver's image capture, the driver's face recognition, etc.

In various embodiments, the connected car 211 may be pre-owned and a previous driver of the connected car 211 likely added identification information (Block 213). For the pre-owned case, stored information is cleared and reset before using the connected car 211 by a different driver (Block 213).

In various embodiments, when the driver's license is scanned, a validation process follows, where the scanned driver's license will be sent to a relevant authority system for validation (Block 214). The validation process checks the driver's license, the vehicle registration, the insurance information, and vehicle identification number, to verify the identification of the driver and the driver's association with the connected car 211, i.e., the connected car 211 is legally occupied and used by the driver (Block 214). If the validation process fails, the connected car 211 will not start. In some embodiments, the driver may choose and/or configure security levels to apply to when and if real time checking of the identification with the authority fails. The security levels include, by way of example, high security level, mid security level and low security level, where each level leads to different actions by the connected car 211 (Block 217). By way of example only, for the high security level, the car 211 will not start, for the mid security level, another opportunity to scan the driver's license may be offered (in case of a different driver having the right to use the connected car 211, such as a family member, a car sharing driver, an emergency responder, etc.). As another example, for the low security level, the security measure can be turned off, but an alert is generated to notify the validation failure.

In various embodiments, the alert can be a text message according to user configured or defined rules, such as sending a text whenever unregistered users attempt to start the connected car 211, etc. Alert triggering criteria can be formulated to accommodate various use cases.

When the validation process succeeds, the car will store information either in the steering wheel system 225 or in the car body, in encrypted form (Block 219). In addition, the authority may store the validation information and provide a pre-approval number or a pre-check status to the driver and the connected car 211. If the identification of the driver, or the driver's use of the connected car 211, may be questioned later, the pre-approval number of the pre-check status can be presented and used to verify the driver 211's use of the connected car 211 (Block 215). Upon completion of the verification, all information can be stored locally within the car (e.g., the processing system of the steering wheel system 225), in cloud, or both, and users/the driver can configure the storage location as a parameter as one of preferences.

FIG. 2D depicts a non-limiting embodiment of a driver identification phase implemented in an intelligent driver assistant system in accordance with various aspects therein. The motion phase of the intelligent driver assistant system such as the steering wheel system 225 as depicted in FIG. 2B is described. In various embodiments, when the driver gets ready to start the car or push a ‘get-ready’ button, a relevant sensor will scan a face of the driver and match the scanned face with corresponding information stored in the storage of the processing system (Block 220). Additionally, biometric information such as a fingerprint can be collected when the driver puts his or her hand(s) on the steering wheel or a suitable location (e.g., a steering wheel cover) for capturing fingerprint information (Block 221). If the face does not match with a photo or an image from the driver's license, the steering wheel system 225 may prompt to the driver an option of scanning a new driver's license or simply cannot start the car (Block 222). As described in connection with FIG. 2C (Blocks 216/217), actions following the match failure may differ and vary depending on the configured or selected security level(s). As described above, the security levels can be configured or set up by the driver.

In various embodiments, the steering wheel system 225 stores identification information of two or more drivers in the processing system of the steering wheel. The connected car 211 can be shared and used by two or more family members who have scanned and stored their driver licenses in the processing system of the steering wheel.

In various embodiments, when the driver is pulled over by authority, such as a police officer, the driver may rely on the identification information stored in the steering wheel (Block 223). The driver can explain to the policer officer, with hands on the steering wheel, that information requested by the policer officer is electronically stored in the processing system of the steering wheel and can be presented to the police officer electronically. As one example, the policer officer is able to see the requested information on various user interfaces, such as a display installed in the connected car 211, on the steering wheel, projected to an interior object, etc. (Block 224). As another example, the requested information can be projected on a windshield, a window close to the police officer, etc. As further another example, the requested information can be projected on the driver's hand, the police officer's hand, etc., if permitted by the police officer. The driver can present to the police officer a verified symbol that proves the verified identification by relevant authority. The police officer may be trained to recognize the verified symbol to facilitate the identification verification process.

In various embodiments, the police officer may carry a scanner or a user equipment that scans the steering wheel to retrieve the identification information (device-to-device) (Block 226). The driver's hands can stay on the steering wheel and the information retrieved by the police officer's equipment, once matched to the stored identification, will likely ensure that the identified information is verified (Block 226).

In various embodiments, if the driver face changes and does not match with the identification photo, the system 210 operates to prompt a message to update the identification photo within a predetermined days. In this case, a bio-check such as matching fingerprints, voice recognition, etc. may pass (Block 228). Blocks 224 and 226 may vary and depend upon the driver's configurations and settings. Additionally, Block 226 may be available and implemented upon arrangement and installation of compatible applications with law enforcement authorities.

FIG. 2E depicts a non-limiting embodiment of a new driver identification phase implemented in an intelligent driver assistant system in accordance with various aspects therein. The new driver identification phase of the intelligent driver assistant system such as the steering wheel implemented system 225 as depicted in FIG. 2B is described. In various embodiments, a new driver does not correspond to a regular driver or an original driver of the connected car 211. For instance, the new driver includes a temporary driver who happens to drive the connected car 211 as the original driver has certain medical conditions and cannot drive (Block 229). Like the registration process of the original driver, as described in FIG. 2B, the temporary driver is also required to scan a driver's license (Block 229). The driver's license of the temporary driver will be sent to relevant authority and identification of the temporary driver can be verified. For instance, it is checked whether a face of the temporary driver matches with an image of the driver's license. However, as the temporary driver is not associated with the vehicle registration and the insurance information of the connected car 211, a verification of the temporary driver will eventually fail with respect to association with the connected car 211 (Block 230).

In various embodiments, when a security level permits, the temporary driver can drive the connected car 211 even if the verification fails (Block 231). As depicted in Block 217 of FIG. 2B, the security level may be configured and set to permit the temporary driver to drive another driver's vehicle to accommodate medical emergency situations. In these situations, however, the temporary driver is required to verify his or her identification information based on a driver's license via a relevant authority system. In other embodiments, the security level may be configured to block any user other than the original driver from using the connected car 211.

In various embodiments, the original driver may receive a notification from the relevant authority about the failed verification attempt (Block 232). In this case, the temporary driver who has triggered the failed verification attempt can be involved in a car theft of the connected car 211. In other embodiments, the original driver may be aware of the temporary driver who attempts to drive the connected car. The original driver may ignore the notification or request investigation depending on the situations involving the failed verification attempt (Block 232). The temporary driver may use the driver's license that is stolen or fabricated and in that case, a scanned face of the temporary driver and a scanned photo of the driver's license will highly unlikely match, which results in verification failure (Block 233).

If the car starts and detects that the driver's heart beating is very high, which is a good indicator that either the driver is nervous (i.e., the act of stealing) or having a medical condition. This can lower the chance of car theft or auto alert local patrol officers. The steering wheel implemented system 225 as depicted in FIG. 2B can also be equipped with IoT sensors to detect heartbeat, temperature, etc., so that under critical medical conditions, such as heart attacks, it can automatically alert the driver, passengers in the car, or remotely hospital, first responders and family members. When asking for a driver's license and a car registration, all the information can be retrieved and displayed on a user interface rather than a traditional way of reaching for a glove compartment.

The steering wheel implemented system 225 as depicted in FIG. 2B can assist first responders and law enforcement officers to better access required information. The system 225 also enhances safety and convenience as information can be displayed without involving much body movement. With correlation of multiple sources, the system 225 can also lower false positives detected by the system such as car theft. The system 225 can automatically connect to and notify law enforcement and emergency services if needed. Before buying a car, new or used or rental, all information from previous users is wiped out.

FIG. 2F depicts an illustrative embodiment of a method 240 in accordance with various aspects described herein. In various embodiments, the method 240 includes scanning, by a processing system including a processor arranged in a steering wheel, identification information of a user and information of a vehicle associated with the user using a first group of sensors integrated with or arranged proximate to the steering wheel (Step 242); verifying, by the processing system, the identification information of the user and the vehicle associated with the user (Step 244), upon the verification, registering and storing, by the processing system, the verified identification information in a data storage of the steering wheel (Step 246); and outputting, by the processing system, the verified identification information on a user interface arranged in connection with the steering wheel of the vehicle (Step 248).

In various embodiments, the method 420 further includes configuring, by the processing system, a plurality of security levels controlling vehicle access, where the plurality of security levels are triggered at least based on the verification of the identification information. The method 420 further includes transmitting, by the processing system, a notification to an owner of the vehicle upon failing to verify the identification information of the user, the vehicle associated with the user, or both. The method 420 further includes scanning, by the processing system, biometric information of the user using a second group of sensors integrated with or arranged proximate to the steering wheel. By way of example, the biometric information of the user comprises fingerprints, facial recognition, voice recognition, iris recognition, or a combination thereof.

FIG. 2G depicts an illustrative embodiment of a method 250 in accordance with various aspects described herein. In various embodiments, the method 250 includes obtaining identification information of a driver and information of a connected car associated with the driver using a first group of sensors integrated with the device or arranged in an interior structure of the connected car (Step 252), transmitting the identification information to a relevant authority system via a communication interface of the connected car (Step 254), receiving verification of the identification information of the driver and the connected car associated with the driver (Step 256), upon the receiving verification of the identification information, registering and storing the verified identification information (Step 258), and outputting the verified identification information on a user interface arranged on the device or in connection with the interior structure of the connected car (Step 260).

In various embodiments, the method 250 includes, upon failing to verify the identification information via the relevant authority system, taking actions to disable the driver from using the connected car, generate an alert, or both. The method 250 further includes receiving biometric information of the driver using a second group of sensors integrated with the device or arranged in an interior structure of the connected car. The method 250 further includes enabling an owner of the connected car to configure one or more security levels applicable to a control of the connected car wherein a highest security level comprises blocking the driver from controlling the connected car when the received biometric information of the driver is not verified. One of the one or more security levels comprises enabling a new driver to control the connected car upon verification of identification information of the new driver via the relevant authority system, even if biometric information of the new driver does not match with the received biometric information of the driver. By way of example, the first group of sensors, the second group of sensors, or both are arranged in a steering wheel of the connected car or a cover for the steering wheel.

In various embodiments, the outputting the verified identification information on the user interface comprises outputting the verified identification on a user display installed in the connected car, on a surface of the steering wheel, or on a windshield of the connected car. The method 250 further includes, upon a request, retrieving the verified identification information using a third group of sensors which is neither a part of the connected car nor arranged in the connected car. For instance, the third group of sensors can be a scanner device such as a radio frequency reader, which can retrieve and recognize the verified identification information. By way of example, a steering wheel of the connected car executes or runs the method 250.

In various embodiments, the method 250 further includes receiving biometric information of the user using a second group of sensors integrated with or arranged proximate to the steering wheel, wherein the biometric information of the user comprises fingerprints, facial recognition, voice recognition, iris recognition, or a combination thereof. The method 250 further includes checking the received biometric information of the user against the stored verified identification information; and upon determining of no match between the received biometric information of the user and the stored verified identification information, generating an alert notifying no match and prompting to rescan the biometric information of the user using the second group of sensors.

In various embodiments, the method 250 further includes disabling the user from controlling the connected car upon receiving no verification information of the user and determining no match between the received biometric information and the scanned identification information.

While for purposes of simplicity of explanation, the respective processes are shown and described as a series of blocks in FIGS. 2F through 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

If connected cars are better and safer, more people will buy connected cars and services. So AT&T can have more cars on our network and more connections. We can work with car manufacturers on creating smart wheels as well as building connections of this idea. Potentially car companies, insurance companies, medical groups, traffic departments, police departments can all benefit from this idea for safety of driving as well as better usage of cars.

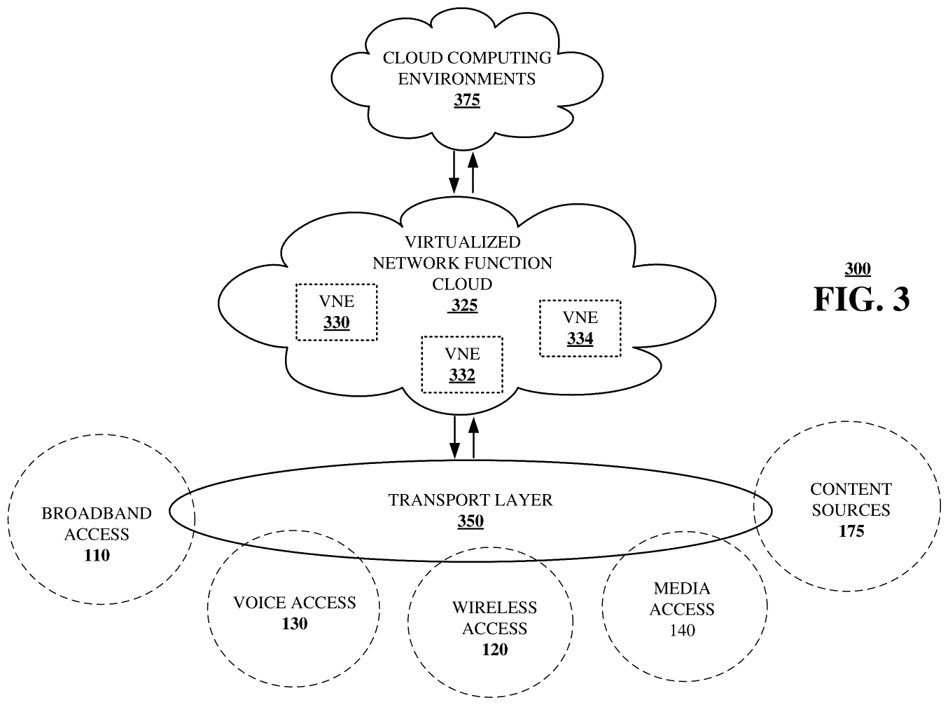

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part intelligent driver assistance systems and methods for use in connected cars.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

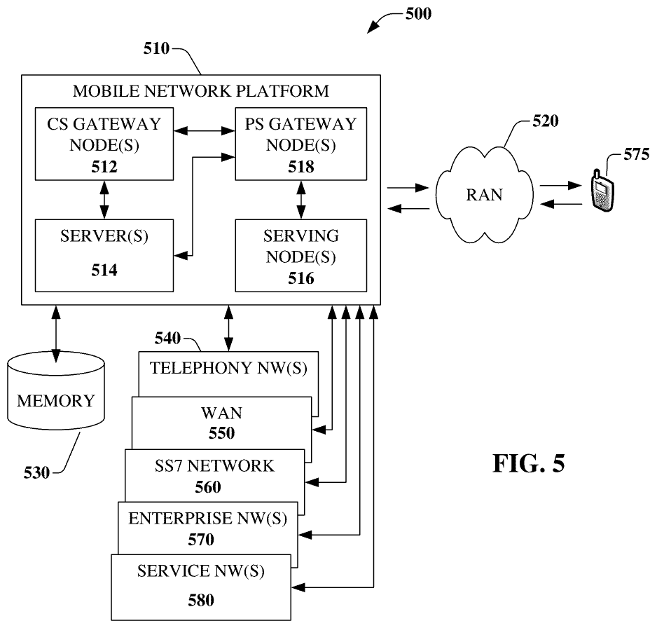

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part intelligent driver assistance systems and methods for use in connected cars. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

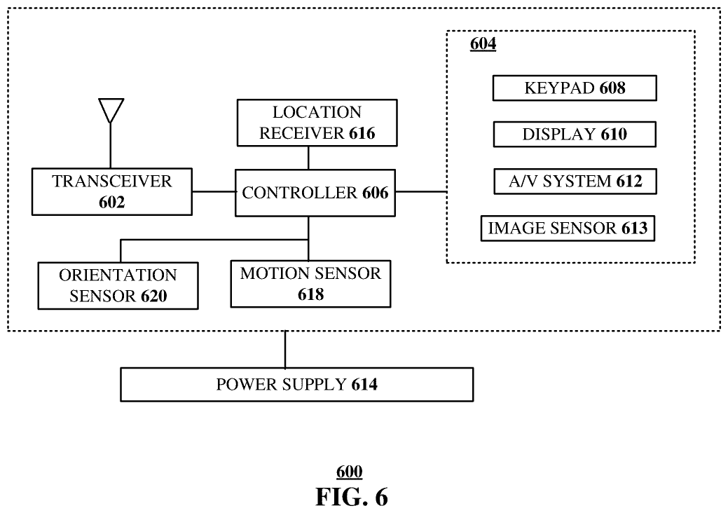

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part intelligent driver assistance systems and methods for use in connected cars.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances.

In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining identification information of a driver and information of a connected car associated with the driver using a first group of sensors integrated with the device or arranged in an interior structure of the connected car;
transmitting the identification information to a relevant authority system via a communication interface of the connected car;
receiving verification of the identification information of the driver and the connected car associated with the driver;
upon the verification of the identification information, registering and storing the verified identification information; and
outputting the verified identification information on a user interface arranged on the device or in connection with the interior structure of the connected car.

2. The device of claim 1, wherein the operations further comprise, upon failing to verify the identification information via the relevant authority system, taking actions to disable the driver from using the connected car, generate an alert, or both.

3. The device of claim 1, wherein the operations further comprise receiving biometric information of the driver using a second group of sensors integrated with the device or arranged in the interior structure of the connected car.

4. The device of claim 3, wherein the operations further comprise enabling an owner of the connected car to configure one or more security levels applicable to a control of the connected car, wherein a highest security level comprises blocking the driver from controlling the connected car when the received biometric information of the driver is not verified.

5. The device of claim 4, wherein one of the one or more security levels comprises enabling a new driver to control the connected car upon verification of identification information of the new driver via the relevant authority system, even if biometric information of the new driver does not match with the received biometric information of the driver.

6. The device of claim 3, wherein the first group of sensors, the second group of sensors, or both are arranged in a steering wheel of the connected car.

7. The device of claim 1, wherein the outputting the verified identification information on the user interface comprises outputting the verified identification information on a user display installed in the connected car, on a surface of a steering wheel, or on a windshield of the connected car.

8. The device of claim 1, wherein the operations further comprise:
upon a request, retrieving the verified identification information using a third group of sensors which is neither a part of the connected car nor arranged in the connected car.

9. The device of claim 1, wherein the device is a steering wheel of the connected car or a cover for the steering wheel of the connected car.

10. A non-transitory machine-readable medium, comprising executable instructions that, when executed by a processing system including a processor, facilitate performance of operations, the operations comprising:
scanning identification information of a user and information of a connected car associated with the user using a first group of sensors integrated with or arranged in a steering wheel of the connected car;
transmitting the identification information of the user to a relevant authority system via a communication interface of the connected car;
receiving verification of the identification information of the user and the connected car associated with the user;
upon the receiving verification of the identification information, registering and storing the verified identification information; and
outputting the verified identification information on a user interface arranged in connection with the steering wheel of the connected car.

11. The non-transitory machine-readable medium of claim 10, wherein the operations further comprise receiving biometric information of the user using a second group of sensors integrated with or arranged proximate to the steering wheel, wherein the biometric information of the user comprises fingerprints, facial recognition, voice recognition, iris recognition, or a combination thereof.

12. The non-transitory machine-readable medium of claim 11, wherein the operations further comprise:
checking the received biometric information of the user against the stored verified identification information; and
upon determining of no match between the received biometric information of the user and the stored verified identification information, generating an alert notifying no match and prompting to rescan the biometric information of the user using the second group of sensors.

13. The non-transitory machine-readable medium of claim 11, wherein the operations further comprise disabling the user from controlling the connected car upon receiving no verification information of the user and determining no match between the received biometric information and the scanned identification information.

14. The non-transitory machine-readable medium of claim 11, wherein the operations further comprise:
scanning identification information of a temporary user and the information of the connected car using the first group of sensors;
upon transmitting the identification information of the user to the relevant authority system via the communication interface of the connected car;
receiving verification of the identification information of the temporary user and receiving failure to verify association of the temporary user with the connected car;
receiving biometric information of the temporary user using the second group of sensors; and
enabling the temporary user to control the connected car upon matching of the biometric information of the temporary user with the verified identification information.

15. The non-transitory machine-readable medium of claim 11, wherein the operations further comprise receiving health state information of the user using the second group of sensors, where the health state information of the user comprises a heart bit rate of the user or a posture of the user indicative of a dozing off state or an unconscious state.

16. The non-transitory machine-readable medium of claim 10, wherein the outputting the verified identification information on the user interface further comprises outputting the verified identification information on a user display installed in the connected car, on a surface of the steering wheel, or on a windshield of the connected car.

17. A method, comprising:
scanning, by a processing system including a processor, identification information of a user and information of a vehicle associated with the user using a first group of sensors integrated with or arranged proximate to a steering wheel;
verifying, by the processing system, the identification information of the user and the vehicle associated with the user;
upon the verification of the identification information, registering and storing, by the processing system, the verified identification information in a data storage of the steering wheel of the vehicle; and
outputting, by the processing system, the verified identification information on a user interface arranged in connection with the steering wheel of the vehicle.

18. The method of claim 17, comprising:
configuring, by the processing system, a plurality of security levels controlling vehicle access, wherein the plurality of security levels are triggered at least based on the verification of the identification information.

19. The method of claim 17, comprising:
transmitting, by the processing system, a notification to an owner of the vehicle upon failing to verify the identification information of the user, the vehicle associated with the user, or both.

20. The method of claim 17, comprising:
scanning, by the processing system, biometric information of the user using a second group of sensors integrated with or arranged proximate to a steering wheel of the vehicle, wherein the biometric information of the user comprises fingerprints, facial recognition, voice recognition, iris recognition, or a combination thereof, wherein the processing system is arranged in the steering wheel of the vehicle.
